(19) United States
(12) Patent Application Publication
(10) Pub. No.: US 2019/0197466 A1
(43) Pub. Date: Jun. 27, 2019

(54) INVENTORY CONTROL FOR LIQUID CONTAINERS

(71) Applicant: E-Commerce Exchange Solutions, Inc., Safety Harbor, FL (US)

(72) Inventors: George Patrick Hand, III, Safety Harbor, FL (US); Lansing J Stewart, Bainbridge Island, WA (US); Joe J Stewart, Clearwater, FL (US); Hitesh Shah, Brampton, ON (CA); Chintankumar Kamleshkumar Modi, Sarnia, ON (CA)

(21) Appl. No.: 15/855,088

(22) Filed: Dec. 27, 2017

(51) Int. Cl. G06Q 10/08; G06F 17/30; H04N 7/18; G06K 9/62

(52) U.S. Cl. CPC G06Q 10/087; G06F 17/3028; G06N 99/005; G06K 9/6269; H04N 7/185

(57) ABSTRACT

Systems and methods are provided for taking the inventory of liquids dispensed in full and partially filled containers. An electronic device captures images of containers and associated liquid volumes. The containers are identified by a shape, label, universal purchasing code, or other identifying means using a graphical user interface input/output. An image of the container is displayed and a border around the container is provided to create a duplicate thereof as well as the total volume. Pixel imaging of the container and contents (including meniscus detection) is achieved through detecting connected pixels. A volume of liquid remaining in the container is determined as a function of the connected pixels and an inventory including amounts of particular liquids is provided by utilizing convolutional neural networks. The system and methods allow accurate liquid inventory while limiting human input to operating the electronic device to capture the initial image of the container.

### FIELD

The present technology relates to inventory control of products using machine learning techniques, and in particular, for taking inventory of an amount of a liquid product in one or more containers, including containers holding various amounts of liquids, over a period of time.

### INTRODUCTION

This section provides background information related to the present disclosure which is not necessarily prior art.

The inventory and control of beverages, such as liquor, by way of example, is a pressing problem in any business that dispenses liquid, for example, on a daily basis. It is necessary for businesses such as restaurants, bars and nightclubs, to maintain a running inventory of beverages on hand. It is estimated that establishments having inventories of beverages within containers have shrinkage rates of 23%. In other words, one in four drinks disappears as a result of spillage, evaporation, or unaccounted for consumption. Shrinkage arises in part from a lack of accounting for inventory on a daily basis.

Although point of sale data can be used as an estimator of the amount of beverages consumed during business hours, it does not account for waste, spillage, free drinks, or even evaporation (collectively known as shrinkage). Nor does point of sale data account for any inconsistencies in the amount of beverages consumed from order to order when liquids are free-poured by a variety of employees to fulfill orders. Point of sale data only provides a count of drinks ordered and estimates the amount of beverages consumed based upon an idealized recipe for each sale; e.g., each order is made with exactly the same amount of liquid regardless of who prepares it. Therefore, although the point of sale count is adequate in some circumstances, it suffers from the shortcoming that it does not account for a significant amount of the beverage consumption and is inaccurate in its inventory estimate, because it counts sales, not consumption.

In order to overcome this shortcoming, inventory can be determined on a periodic basis through manual labor. An employee of the establishment can count the number of bottles having liquid in them, which is a function of a total amount of each liquid consumed during that time period, and can estimate the amount of liquid remaining in any open containers to arrive at an adjusted or updated inventory. This way of taking inventory can function satisfactorily in certain instances and continues to be used; however, such manual methods suffer from the deficiency that they can be labor intensive, often taking hours of one or more employees' time. If manual inventory is performed during business hours, an employee performing the task may become distracted by the competing responsibilities of the job during business hours or just the general distractions of the commotion in the environment of a bar, nightclub, or restaurant. Furthermore, an accurate inventory is almost impossible during business hours as containers of beverages are continuously being dispensed and consumed. If the inventory job is performed after hours, then the employee may often be tired and the process may be prone to human error. Such manual inventory taking can consequently be extremely inaccurate and can require the same person to perform inventory every time in order to provide consistent eye-balled estimations of liquid remaining in open containers. What is more, as manual inventory can also takes five to six employee hours or more to complete, it can be impractical to perform on a daily basis, leaving establishment owners and managers unsure of actual inventory assets on a daily basis.

Automated inventory taking systems have been developed, such as those known from U.S. Pat. Nos. 6,616,037 and 9,576,267, which describe a computer based system, or any other portable computing system like a mobile phone or an electronic tablet with a screen, for taking physical inventory of beverages dispensed in full and partially full containers in an attempt to control theft and over-pouring. These inventory systems are available under the brand names like Partender, Bevspot, Accubar, Invo, Lime Bar Inventory, ChanjFLOW, etc. Such systems can scan bar codes on the bottles to identify product information about the scanned bottle and provide a silhouette of a bottle to the user on a screen (e.g., a graphical user interface or GUI) of a computing device. The user indicates, by touching the silhouette of the bottle on the screen, or by using a sliding member available on the GUI, an estimate of a fluid level within the bottle. They may touch the full symbol, empty symbol, or some intermediate symbol to input the quantity of beverage remaining in a partially filled bottle that has been scanned. These inventories are then processed to provide totals for the currently available stock. One limitation of such systems, however, is the requirement of a bar code to be scanned for each inventoried bottle. These systems function satisfactory in certain instances, however, they can be too time intensive and, as a result of general input icons such as full, empty, quarter or the like, or fat thumb processing by touching the screen with a user's finger, can be subject to mis-processing and be limited in accuracy as a result of the screen size and finger size of the user results, and can cause confusion amongst users. Intentional manipulation by the user can also result in processing mistakes and inaccuracy.

Another very basic and simplistic approach of container or bottle liquid inventory is to use a scale where the weight of the container between successive measures is used to calculate the inventory usage. There are inventory systems available which use normal or Bluetooth™ weigh scales for liquid inventory, for example, including SpeedBAR Lite liquor inventory, BarMAXX, Bar Patrol, and bar-i-liquor. One such system is defined by patent number U.S. Pat. No. 5,986,219. The inventory system described therein requires equipment such as a calibrated weigh scale. If used for bar liquor inventory the person taking the inventory must remove each bottle from its normal position to weigh it, then replace the bottle where it belongs. This is inefficient and time consuming leading to cumulative increased costs. It addition, there is a capital cost for the weigh scale or a weigh scale system.

Other inventory systems and methods available for inventory of liquid bottles or liquid containers are available. These include where a mobile computing device captures a barcode and sends the barcode to a database which contains pictures of various bottles; e.g., U.S. Pat. No. 9,576,267. Based on the barcode received, a server sends back an image of the liquid bottle. The human user can look at the image of the bottle, look at the opened bottle, and based on their eyesight, perception, and their own individual learning, move a sliding member on the image of the bottle provided by the system to approximate the liquid level contained therein. This reference of the liquid level marked by the user's finger is sent to another computing device to calculate the volume of the remaining liquid. Human intervention is prevalent, and dishonest manipulation by the user is possible. There are also inventory systems available that combine barcode reading and weight determination using a scale to perform the inventory. Some examples include SPEEDBAR and Bevinco mobile apps. There is another inventory system, Inventory Bar mobile app, available in which the user needs to take picture of a bottle three times, including taking a picture of full bottle, a picture of the cap of bottle, and a picture of the bottom of the bottle to perform inventory.

These various manual and partially automated methods and systems for inventory of liquid bottles or liquid containers therefore often involve human input to approximate or identify a liquid level in each container. Such methods rely on human vision and perception, as well as estimation, with respect to marking a liquid level. Such estimates of the liquid level of an opened bottle and marking the level of the same on a bottle picture provided on a computing device are consequently subject to human error and intentional deceptive manipulation. Methods having a GUI and a sliding member may not be any more accurate, because they rely on human visual senses, perception, and user familiarity with the interface. Some methods overcome the accuracy issue in taking inventory by weighing containers to accurately measure the amount of liquid remaining therein, but weighing each container is cumbersome and requires extra monetary expenses for the user, as noted.

There are methods and systems available for product inventory or searching an image having a single object in a database containing multiple images of similar single objects, based on image processing and an artificial neural network. For example, U.S. Pub. No. 2017/0124618A1 and US Pub. No. 2016/0350336A1 describe where a user captures an image of the product they want to purchase or search in a database. The image is sent to a database having features computed from images and includes a trained neural network based on support vector machine (SVM) or multilayer perceptron (MLP) or deep learning algorithm or convolutional neural network (CNN) based algorithm to classify the image to be a particular class of image. The product image sent by the user is preprocessed using various image preprocessing techniques like: image scaling, histogram equalization, edge sharpening, Canny edge detection, and median filtering. Feature vector for the new image is computed using scale invariant feature transform (SIFT) or speeded-up robust features (SURF) or oriented BRIEF (ORB) or histogram of oriented gradients (HOG). The feature vector is sent to SVM or MLP or CNN for classification. The end result is a list of similar images and/or the weblink to purchase them.

Image tilt and orientation correction systems are available, for example, U.S. Pat. Nos. 9,113,078; 9,568,742; 8,908,053; and CN Pat. No. 103208119B, in which an image capturing device uses image tilt and orientation correction using an accelerometer and distance measuring sensor. The image capturing device can utilize the orientation data and/or distance data to interactively indicate a level of perspective distortion to the user and allow the user to adjust the physical orientation of the image capture device to correct the distortion. For example, dynamic crop lines or a virtual level may be displayed to the user to indicate the action necessary to level the camera.

To detect objects automatically from an image, detection of one or more landmark points is a very important step. A landmark point is a point in the shape of an object in which correspondences between and within the populations of the object are preserved. Landmark points can be defined either manually by human markers or automatically by a computing device. Ensemble of regression trees is one of the methods that can automatically detects landmark points of objects available in an image. Ensemble of regression trees is used to detect landmark points of faces in U.S. Pat. No. 9,633,250 and WO2017029488A2.

Accordingly, ways to overcome the shortcomings of the aforementioned inventory systems and methods would be advantageous, where one can more accurately and quickly inventory partially filled containers. Inventory systems and methods that remove human error by reducing or eliminating the dependence on human visual senses, visual perception, and/or motor skills would be beneficial to maximizing inventory accuracy. It would also be desirable to have systems and methods that can replace human estimates by making use of a computing device and different sensors embedded within the same computing device or by providing one or more additional non-embedded sensors. It would also be advantageous to improve the accuracy as well as the speed in ascertaining inventory, especially where a synergism can be achieved through the use of various computing devices and sensors, including one or more: embedded camera sensors; embedded gyro sensors; embedded accelerometers; embedded global positioning system sensors; barometers; magnetometers; proximity sensors; UPC barcode scanning of the opened container for which the inventory is being done; image capture of an opened container for which the inventory is being done; automatic detection of liquid level in the container by using artificially trained neural network, by using a machine learning technique, and/or by using various image processing techniques; transmission of the information of liquid level to a database for computation of volume of the remaining liquid in a container; and combinations thereof.

### SUMMARY

The present technology includes articles of manufacture, systems, and processes that relate to rapidly and accurately assessing inventory of liquids within various containers.

An inventory of a liquid in a container can be obtained using a mobile device, a database, a computational device, and a reporting means. The mobile device includes a sensor that is configured to capture an image of the container. The database is configured to store an attribute of the container. The computational device is in communication with the mobile device and is in communication with the database. The computational device is configured with an image processing means that is able to process the image of the container to (1) identify a type of the container by using the attribute of the container and to (2) identify the liquid in the container. The computational device is also configured to determine an amount of the liquid in the container using the type of the container identified by the image processing means and using the liquid in the container identified by the image processing means. The reporting means is configured to report the amount of the liquid in the container determined by the computational device.

Aspects of the disclosed subject matter include methods and systems for reliable and accurate inventory for liquid containers, which remove a dependence on human visual senses, including visual perception or human brain power, for inventory of liquid containers. The methods and systems provided herein minimize human error and/or intentional deceptive human manipulation in determining inventory by making use of a computing device and different sensors embedded within the same computing device or by providing additional non-embedded sensors.

The present technology can automate various aspects of the inventory task by implementation of different functional modules in a way that the images captured, the markings done by a human, the database developed for landmark points, etc., during the initial and successive progressive implementation of the inventory system is used to train various machine learning techniques based functional modules. See the table provided as FIG. 1(A-C). All the implementations can co-exist within the inventory system so that different mobile computing devices can take advantage of various combinations of functional modules, however, and as time progresses the inventory system can achieve automation by self-learning and model refinement through its progression in time.

Referring again to FIG. 1(A-C), for some mobile computing devices the system may utilize multiple options listed therein to accomplish functional tasks. Combinations of options listed can also co-exist on different devices simultaneously. Coexistence can be the result of the difference in the computing devices being used by different users. Different switching modules can decide the combination of functional modules and hence many combinations of functional modules are possible and are part of the inventory system.

Implementation of the present inventory system can include capturing images using a white or plain background having a known landmark design, for example, by using five or more landmark points or dots. This can allow the user to ensure proper orientation and tilt of the camera before capturing the picture. The initial implementation of the inventory system can improve the accuracy of the liquid volume detection by sending the image captured by the user to a cloud server, where human markers can mark the top, bottom, and liquid (meniscus) level available in the bottle or liquid container. Based on these markings and the five landmark points, a functional module maps the real world coordinates into image coordinates that can be further utilized in computation of the remaining volume of liquid in the container; e.g., volume in milliliters (mL). The uniqueness of the present inventory system, by utilizing the computational power and memory of mobile computing devices, eliminates the need for human intervention after the image is captured by the digital camera.

One or more sensors of the inventory system, including the sensor of the mobile device, can be configured to capture a plurality of time stamped images of a plurality of containers from a plurality of recorded relative spatial orientations. The computational device can be configured with an image processing means to identify a plurality of individual containers that have moved with respect to each other from one time stamped image to another. And the reporting means can be configured to report the containers which have moved from one time stamped image to another. In this way, for example, the system can provide a comparison of a container or a plurality containers from one time point (e.g., day 1) with an image from another time point (e.g., day 2, and so forth), and can identify any containers that moved or changed from one time point to the next. An area for storing or holding several containers can accordingly have a series of time stamped images taken thereof; e.g., a shelf behind a bar, a liquor cabinet, a cooler, etc. Containers that moved or changed are the only ones that may need to be considered for further inventory analysis. The system can therefore focus only on containers that need to be inventoried or measured for changes, where limiting analysis in this fashion can increase processing speed of the inventory. It is further noted that a video is a series of images and can provide a series of time stamped images. Accordingly, the inventory system can interface with various imaging sensors, cameras, video cameras, security cameras, as well as allowing the user the option of scanning the bar with mobile device to acquire a video (e.g., a series of photos) and have the inventory system compare and identify what containers have moved and select the moved containers as those to be inventoried.

The progression of implementation of the inventory system further improvises in automating the inventory system by allowing the user to take a video (e.g., a timed series of images) with the mobile device that tells the end user the progress towards inventory analysis completion. In this case, the user may use his/her smartphone to start an application that implements the inventory system in real time wherein a series of images, in the form of a live video feed can be taken in succession from numerous positions or angles in 3D space (e.g., scanning a bar shelf full of containers), and shared with the database via telecommunication (e.g., wifi). Based on these time stamped images, the mobile device can be configured with an image processing means to identify one or more containers that have moved with respect to each other from one time stamped image to another. In turn, this enables the reporting means to report the containers which have moved from one time stamp to another. With this information, the inventory system can be configured to measure the liquid for only the containers that moved with respect to a fiducial (e.g., shelf) or to each other. In this way, computational power is dedicated to focusing only on the containers that could have contributed to change in inventory from one time to another (e.g., day 1 vs. day 2). In this example, comparison of day 1 to day 2 shelf can identify the containers that moved or were changed from one day to the next. Containers that moved or changed are the only ones that need to be considered for further analysis. Image analysis can identify even a 1 mm movement or rotation, and if no movement of the container occurred, then no change in inventory for that container may be recorded. This way, computing of inventory is fast and focuses only on the bottles that need measurement. The inventory output to the back-end inventory system will also be much faster.

The speed for inventory calculations using time stamped image analysis can also allow the system to read out to the end user the progress in collection of inventory. This enables the user to simply walk around the physical inventory taking multiple pictures as a video feed from various spatial locations and the system can read out increasing % coverage of inventory, from 0% to 100%, at which time the user can shut down the system or read out further the inventory. Such improvements make the inventory system very user friendly and ensure compliance and accuracy in data collection. A speed gain in preserving computational power to focus only on containers that have moved enables the computational power to be focused on resolving the liquid level changes in individual containers that are the only ones which could have a change (because they moved or were replaced). This implementation of the inventory system ensures a user friendly feature for inventory readout with clarity to accurate completion and user feedback on progress.

The progression of implementation of the invented inventory system further improvises in automating the inventory system by utilizing various image processing features based upon machine learning techniques, as provided in FIG. 1A-C. Images captured for a specific brand and size of a liquid container by previous implementation of the inventory system can be used to train a machine learning functional module for the current inventory being assessed by the inventory system. In this implementation of the inventory system, a user captures a picture using a background having known landmark marking design, for example, five dots. The user, however, can utilize the visual guidance provided for sizing and orientation correction. Image features (e.g., RGB, YUV, HOG, Local binary patterns, etc.) are extracted and send it to a trained classifier network (e.g., SVM, Binary classifiers, HAAR, Viola-Jones) to automatically identify inventory for the liquid container. In this implementation of the inventory system, a landmark detection functional module identifies landmarks using image processing techniques (e.g., Ensemble of regression trees) for a specific brand and size of liquid container. The system can automatically identify a liquid meniscus level using a combination of image processing and machine learning approaches. Similar to the initial implementation of the inventory system, a functional module on a cloud server or on a primary computing device can automatically map the real world landmark points and top, bottom, and meniscus level points to image pixel points using progressive geometry transformations as identified by a stick model. In this implementation of the inventory system, a functional module on a cloud server or on a primary computing device can automatically map the liquid percentage to a fluid measurement (e.g., mL) and can send it to a database to log the inventory of a particular bottle.

A landmark detection functional module can utilize a database of pre-computed landmark points. The database can include various types, brands, and sizes of liquid containers to achieve accuracy in landmark detection.

The progression of implementation of the inventory system further improvises in automating the inventory system by utilizing various machine learning techniques as listed in FIGS. 1A-C and FIG. 11. One or more images captured and processed using previous implementation of the inventory system for specific brands and sizes of liquid containers can be used to train machine learning functional module/s for this implementation of the inventory system. Different machine learning techniques can be trained for different functional modules. Each and every functional module can also be automated. See FIGS. 1A-C and FIG. 11. The functional modules related to image localization, landmark detection, meniscus detection, stick model projective geometry transformation, and liquid percentage to mL conversion can each have their own machine learning technique(s) (e.g., convolutional neural network) trained to perform the tasks automatically as identified in the ‘Functional Task’ column of the table of FIG. 1A-C. The table in FIG. 11 also includes various aspects and examples related to the operation of the modules described herein.

Images captured and processed in different machine learning techniques for different steps outlined herein can be used to train a single machine learning technique (e.g., a neural network) in automating aspects of the present inventory system. A single machine learning technique (e.g., convolutional or deep neural network) can be trained to perform all the tasks identified in FIG. 1A-C, in order to automatically perform the inventory of one or more liquid containers.

The inventory system can remove the need of a background, a weigh scale, additional human intervention, and hence can minimize capital costs in performing inventory. A smart device (e.g., cell phone) is a commonly owned device already in use at nearly all businesses. By taking the inventory photo in-situ using the smart device, the present technology improves timing efficiency as compared to weigh scale based systems where a bottle needs to be physically picked up, needs to be put on weigh scale, and then must be returned to its original location, where these actions consume a lot of time and are labor intensive. There is also an inherent smaller likelihood of cheating (e.g., adding liquid to dilute the liquor) believed to occur when the bottles remain in-situ and are not removed from their normal positions during inventory.

The present technology accordingly includes one or more of the following features:
(1) provide/s a graphical user interface (GUI) showing a liquid container's brand information, size information, or any other relevant information, where the GUI can also provide the user with the ability to select a particular brand of the liquid container for which he or she wants to perform the inventory;
(2) use/s computing device's various embedded sensors, such as an embedded camera sensor, embedded gyro sensor, embedded accelerometer, embedded global positioning sensor, ambient light sensor, etc. to find orientation, centering, and other additional information;
(3) use/s the orientation data and/or centering information of various embedded sensors to interactively indicate a level of perspective distortion to the user and allow the user to adjust the physical orientation of the image capture device to correct the distortion or automatically corrects for the perspective distortion;
(4) read/s UPC bar code of the opened bottle for which the inventory is being done;
(5) automatically capture/s image of opened bottle when the desired orientation of image is achieved or allow/s the user to capture the image of the bottle for which the inventory is being done along with surrounding bottles or other objects in the background;
(6) send/s the captured image to another processing device for processing the following steps on to a secondary processing machine or it can perform the following steps on the mobile computing primary device;
(7) automatically find/s the image of the bottle for which the inventory is being done from the surrounding bottles or other objects in the background by using an artificially trained neural network or by using various image processing techniques;
(8) automatically find/s the landmark points available specific to the liquid container brand already selected by user by using an artificially trained neural network or by using various image processing techniques;
(9) automatically find/s the liquid level or meniscus level in the bottle or liquid container by using an artificially trained neural network or by using various image processing techniques;
(10) automatically correct/s for projective geometry and translated measurement in real-world coordinate space by applying computer vision based techniques on landmarks & meniscus identified image;
(11) calculate/s the volume of the remaining liquid in the liquid container user defined units by combining domain and a bottle specific model on the real-world coordinate space;
(12) send/s the computed volume information to liquid containers' inventory database server;
(13) displays the inventory information on any analytic inventory system platform; and
(14) refine/s various functional modules' implementations by using the current results in aggregation with prior results and/or human feedback to update models in all or any of the steps.

Referring to FIG. 2, using methods and systems according to the disclosed subject matter, some of the functional modules functional tasks are accomplished in a primary computing device, for example a mobile phone or tablet, while some of the steps can also be performed in any other secondary computing device, for example a remote cloud server. The information data flow shown in FIG. 2, is one of the many possible combinations of data flow. There can be multiple ways of data flow possible because of the multiple possible combinations of functional modules.

Methods and systems according to the disclosed subject matter contain the following functional modules that are realized by implementing the modules on various computational devices. The methods and systems according to the disclosed subject matter utilize various functional modules in different combinations depending on the mobile computing device's capability. One or more modules can be combined in any order with one or more additional modules. The functional module combinations shown in FIG. 3, for example, are one of the many possible combinations of functional modules, where various sub-combinations and different orders of the shown modules can be used. The modules shown in FIG. 3 can be further described as follows:
Graphical User Interface (GUI) functional module: the methods and systems provide a graphical user interface (GUI) showing a liquid container's brand information, size information, or any other relevant information. The GUI also provides the user with the ability to select a particular brand of the liquid container for which he or she wants to perform the inventory.
Orientation and Centering Calculation functional module: the methods and systems use embedded sensors in one or more computing devices, for example, an embedded camera sensor, an embedded gyro sensor, an embedded accelerometer, and an embedded global positioning sensor to find orientation information.
Perspective Distortion Indication and/or correction functional module: the methods and systems use the orientation data and/or centering information of various embedded sensors to interactively indicate a level of perspective distortion to the user and allow the user to adjust the physical orientation of the image capturing device to correct the distortion, or automatically correct for the perspective distortion.
UPC bar code reader functional module: the methods and systems provide facility to read UPC bar code of the opened bottle for which the inventory is being done. This can be further utilized for a bottle-specific inventory system.
Image capture functional module: the methods and systems automatically capture one or more images of opened bottles when the desired orientation of image is achieved or it allows the user to capture the image of the bottle for which the inventory is being done along with surrounding bottles or other objects available in the safe image frame. The user captures reliable and repeatable images of the bottle which are suitable for downstream processing. In this step, the user can be assisted by on screen visual feedback based board sensors on the mobile device. The sensors in this case can include an accelerometer, gyroscope, camera, and/or other sensors.
Primary or Secondary processing device selection functional module: the methods and systems can send a captured image to another processing device for processing the following steps onto a secondary processing machine or can perform the following steps on the mobile computing primary device.
Liquid Container or Bottle Localization functional module: the methods and systems can find the image of the bottle for which the inventory is being done from the surrounding bottles or other objects in the background by using an artificially trained neural network or by using various image processing techniques. Machine learning based techniques are implemented for localizing the bottle in the user captured image. This localization can be coarse (e.g., bounding box) or fine (e.g., per pixel segmentation).
Liquid Container or Bottle Landmark detection functional module: the methods and systems can find one or more landmark points available specific to the liquid container brand already selected by user by using artificially trained neural network or by using various image processing techniques. Machine learning based techniques are implemented on the image patch containing the localized bottle to identifying bottle specific landmarks in the image patch. A patch of an image is a regular size of a small area identified to work with from the original image. As an example, an image having N×N number of pixels may be divided into small picture patch areas of 4×4 pixels resulting in (N×N)/16 image patches.
Liquid Container or Bottle Liquid or Meniscus detection functional module: the methods and systems can find the liquid level or meniscus level in the bottle or liquid container by using artificially trained neural network or by using various image processing techniques. Machine learning based techniques are applied on the image patch containing the localized bottle with or without the landmark's knowledge to identify the meniscus of the liquid.
Projective Geometry Correction and Co-ordinate system conversion “Stick Model transformation” functional module: the methods and systems can correct for projective geometry and translated measurement in real-world coordinate space by applying computer vision based techniques on landmarks and meniscus identified image.
Liquid Container's or Bottle's remaining liquid volume calculation functional module: the methods and systems can calculate the volume of the remaining liquid in the liquid container user defined units by combining domain and bottle specific model on the real-world coordinate space.
Inventory database information linking functional module: the methods and systems can send the computed volume information to an inventory database for the liquid containers.
Inventory analysis and GUI functional module: the methods and systems can implement an analytic GUI and database system on a secondary processing system to provide analytic insights required for inventory management.
Model Refinement functional module: the methods and systems can use the current results in aggregation with prior results and/or human feedback to update models in all or any of the steps.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A, 1B, and 1C provide a tabular format of aspects of the present technology, where functional modules and associated task descriptions are provided for four different versions or embodiments of the present technology, which is referred to as “ScandGO Wizard.”

FIG. 2 is a schematic showing an example of data flow using an embodiment of the liquid container inventory system.

FIG. 3 is a list of functional modules that can be included in various combinations to form embodiments of the liquid container inventory system.

FIG. 4 shows an example of a graphical user interface (GUI) for a device used in the liquid container inventory system.

FIGS. 5A and 5B are representations of how devices and sensors can provide orientation, centering, and perspective distortion indication/correction functions in the liquid container inventory system. FIG. 5C is an example of visual feedbacks that can be provided on a graphical user interface to the inventory user(s).

FIG. 6 is an example of a barcode, such as a universal purchasing code (UPC), reader functional module in the liquid container inventory system.

FIG. 7 is an example of an image capture of various liquid containers using a device in the liquid container inventory system.

FIG. 8A shows identification of a particular liquid container within an image by identification of a bottle shape, FIG. 8B shows identification of a liquid volume remaining within a container image, FIGS. 8C-D show one of the possible ways to perform a fine localization method based on connectivity of pixels. FIGS. 8A-D collectively represent a liquid container's fine localization. FIG. 8E shows implementation details of computation of histogram oriented gradients (HOG) based features from a captured image. FIG. 8F shows coarse localization of a liquid container or bottle using hand marked training data, feature extraction using histogram of oriented gradient (HOG), and classification using support vector machine (SVM). FIG. 8G shows coarse localization of a liquid container or bottle using deep learning convolutional neural network and self-learning feature extraction.

FIG. 9A is an example identification of a liquid container or bottle using landmark identification (dots interposed on the image of the bottle), including the use of ensemble or cascade of regression trees, and FIG. 9B is an example of identification of a liquid container or bottle using landmark identification, including the use of deep learning convolutional neural network.

FIG. 10A is an example of forming a stick model of a liquid container or bottle relative to the bottle dimensions, FIG. 10B is an example of forming a stick model of a liquid container or bottle relative to the bottle label dimensions, and FIG. 10C is an example of transformation of a stick model to real-world coordinates using cross-ratio computation.

FIG. 11 is a tabular display of various functional modules used in the present technology and example of progressive implementations of the respective modules.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

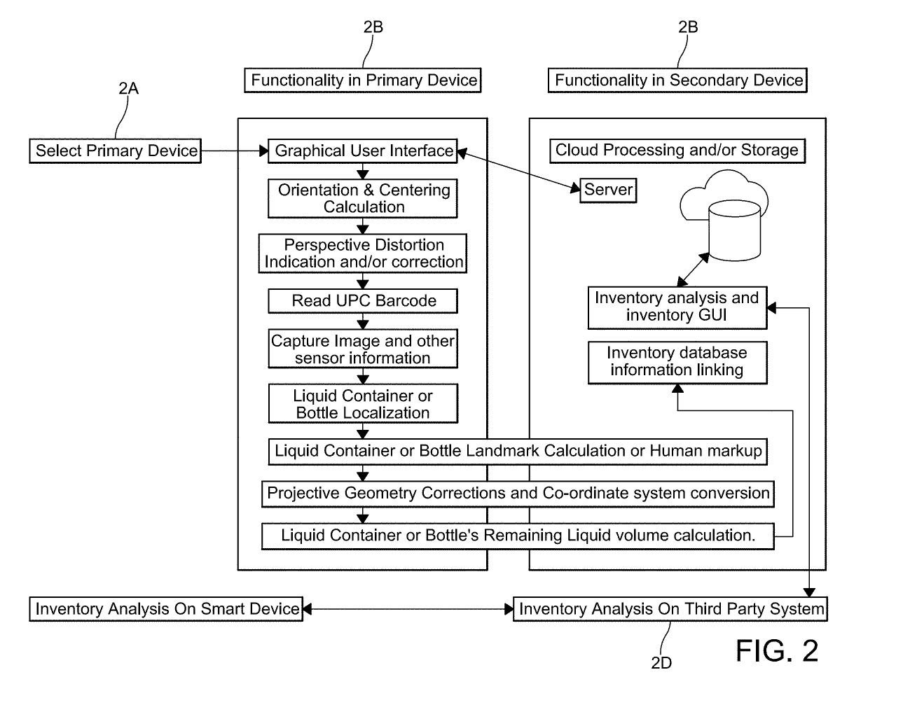

The present technology improves inventory of containers holding various amounts of liquids, including containers that are empty or substantially empty, containers that are full, and containers holding intermediate amounts of liquids. Reference is now made to FIG. 2, where a system and environment are illustrated in accordance with the teachings herein. At step 2A, a computing device, preferably a smart phone, having a graphical user interface (GUI) and a camera thereon by way of non-limiting example can be utilized as a primary processing device. The smart phone can identify a geographic location as well as communicate data utilizing fixed base stations that in turn are in communication with a server, where the server can calculate a geographic location of the smart phone as well as store and process data downloaded from the smart phone. The server may communicate with base stations utilizing any suitable means, such as a conventional telephone network, high speed data lines, SMS communication, or a combination of the foregoing. The server can be controlled by a work station or similar user interface.

A smart phone is used by way of example. However, any computing device having a GUI and the capability to take a picture and transmit and receive data may be utilized as the inventory capture device. These devices may include tablet or even latest generation notepads or laptop computers. Furthermore, a single server is shown and will do the processing as described below. However, this is to facilitate discussion and multiple servers in a cloud configuration may be utilized to execute the invention. Additionally, the present technology is described as being primarily processed using smart devices (e.g., smart phone, tablet, or any other such device having a camera and multiple embedded sensors like gyroscope, accelerometer, GPS, etc.) and servers. However, the calculation of change and inventory can in fact be determined locally using more powerful smart devices, such as tablets, or can be determined remotely on a cloud server.

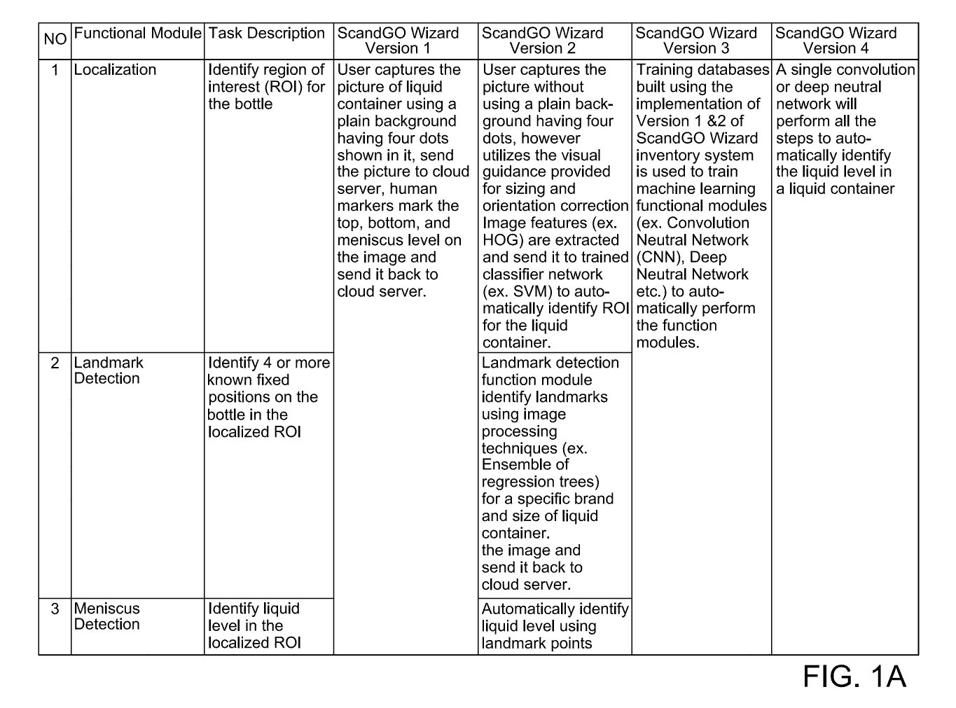

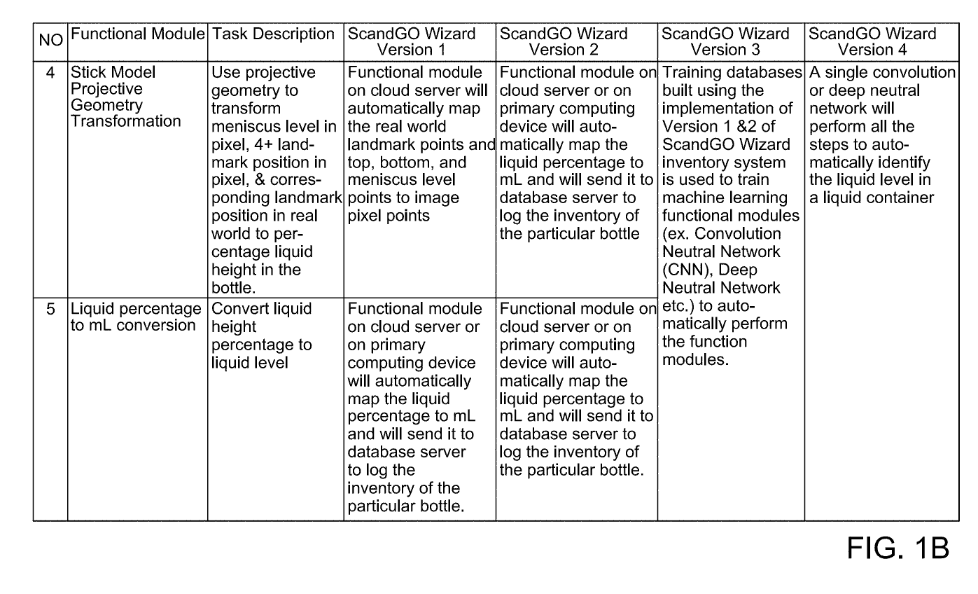

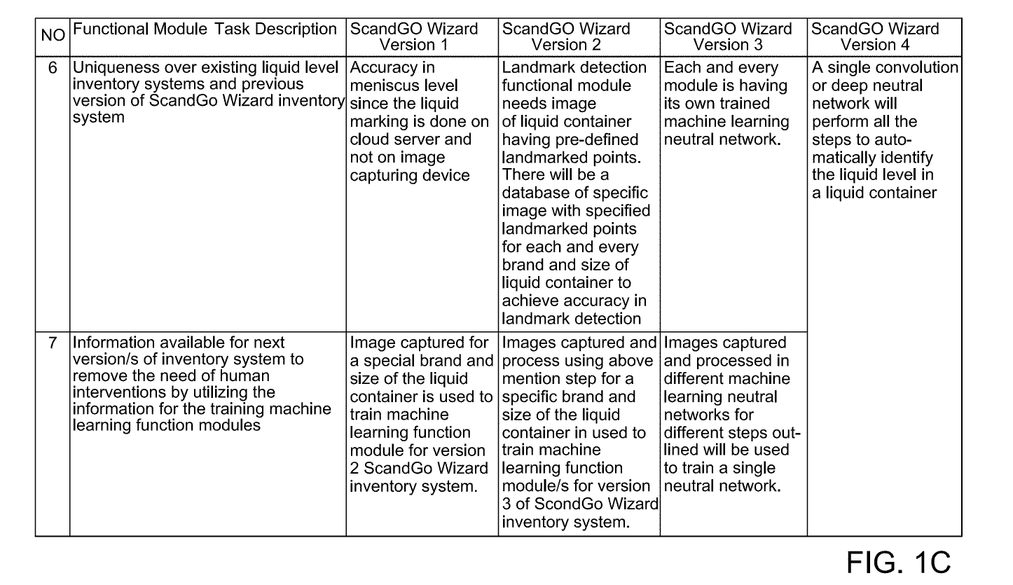

The present technology can utilize primary and secondary processing systems in tandem. Various functionalities of the inventory system can be implemented using different functionality modules as listed in FIG. 2 under the functionality boundaries shown at 2B and 2C. Additional aspects of such modules are found in FIGS. 1A-C, 3, and 11. Some of the functionality modules can be implemented in a primary processing machine, while other functionality modules can be implemented using one or more secondary processing machines. Some of the functionality modules can be implemented in either primary or secondary processing machines or in both primary and secondary processing machines. The logical data flow boundary shown in FIG. 2. is an example only, the data flow boundary between primary and secondary devices may vary depending on the combinations of the functional modules.

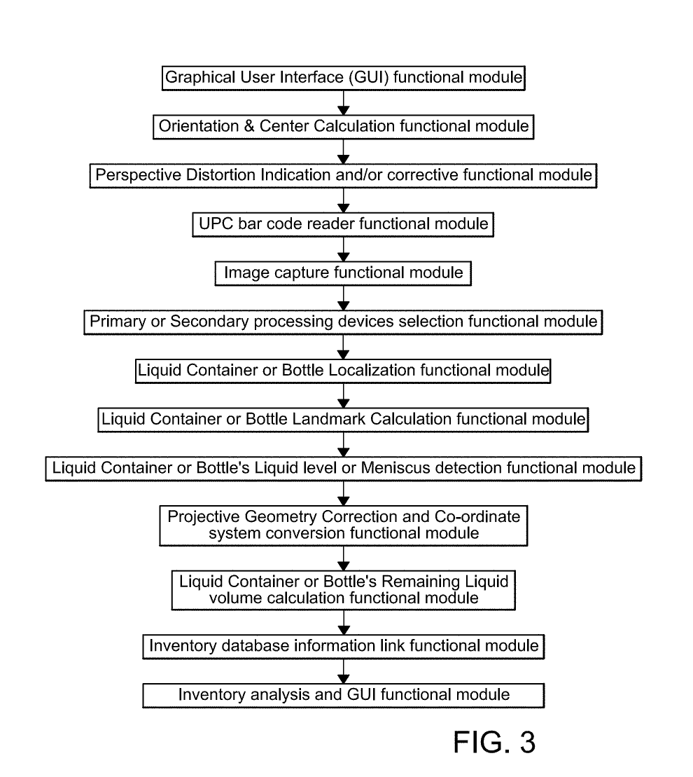

Methods and systems according to the inventory control technology can contain various combinations of functional modules as shown in FIG. 3, which are realized uniquely by implementing combinations of these modules on various computational devices as described in the following sections.

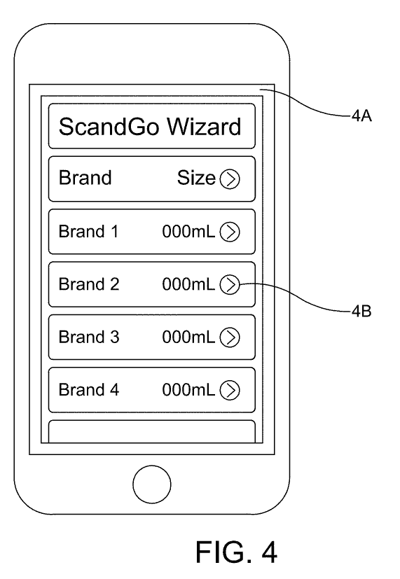

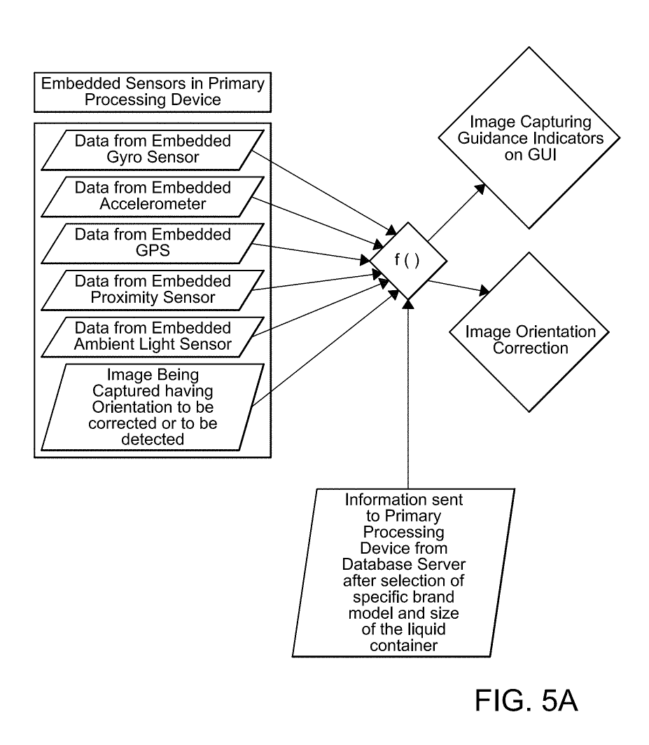

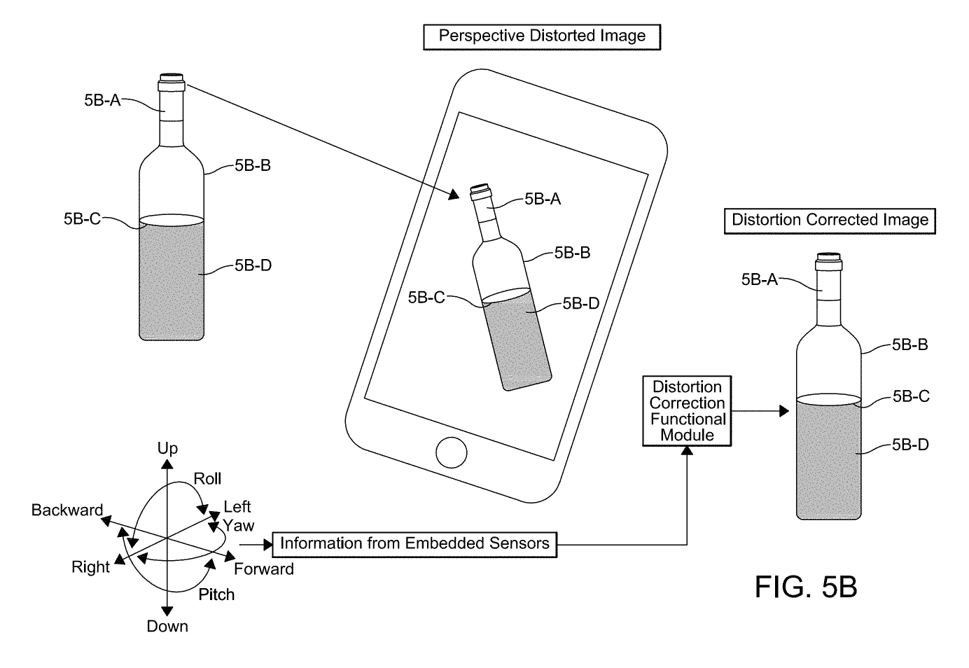

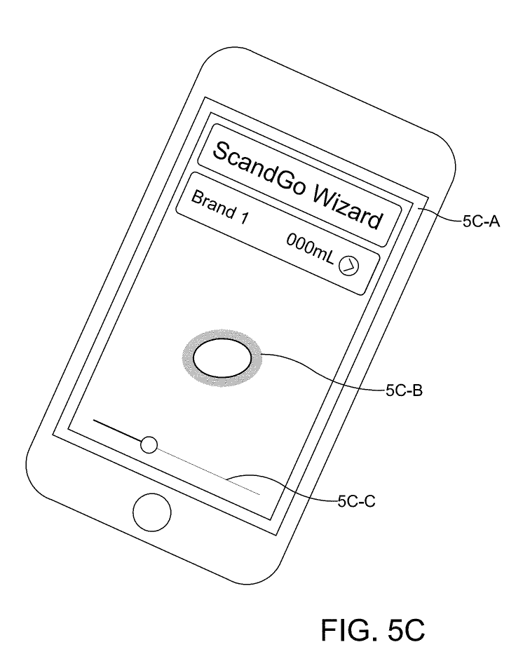

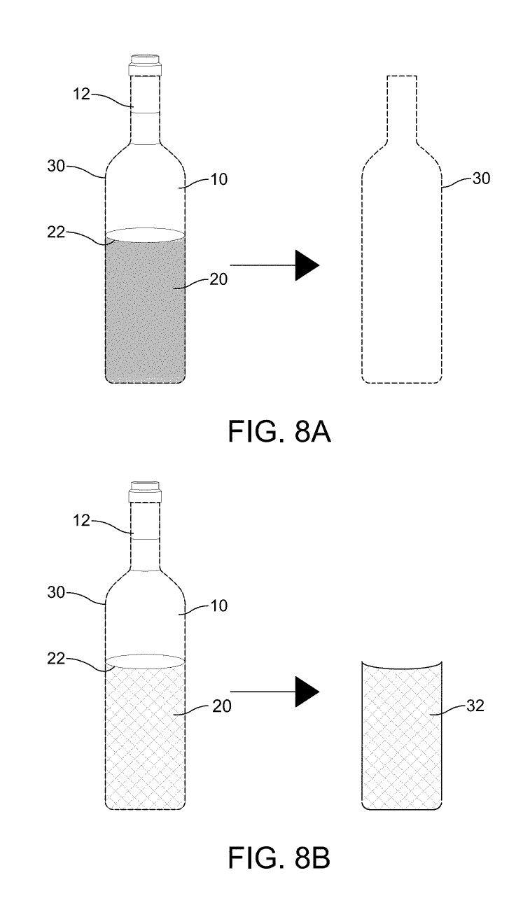

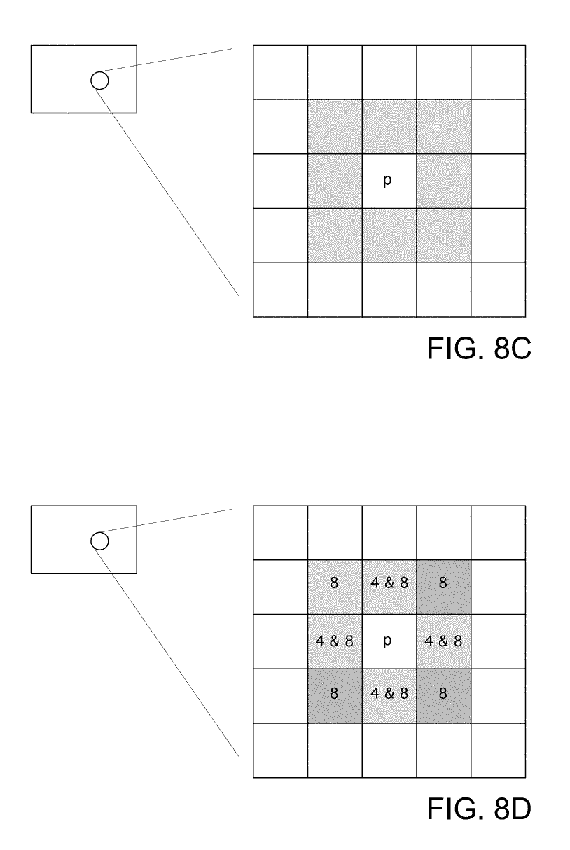

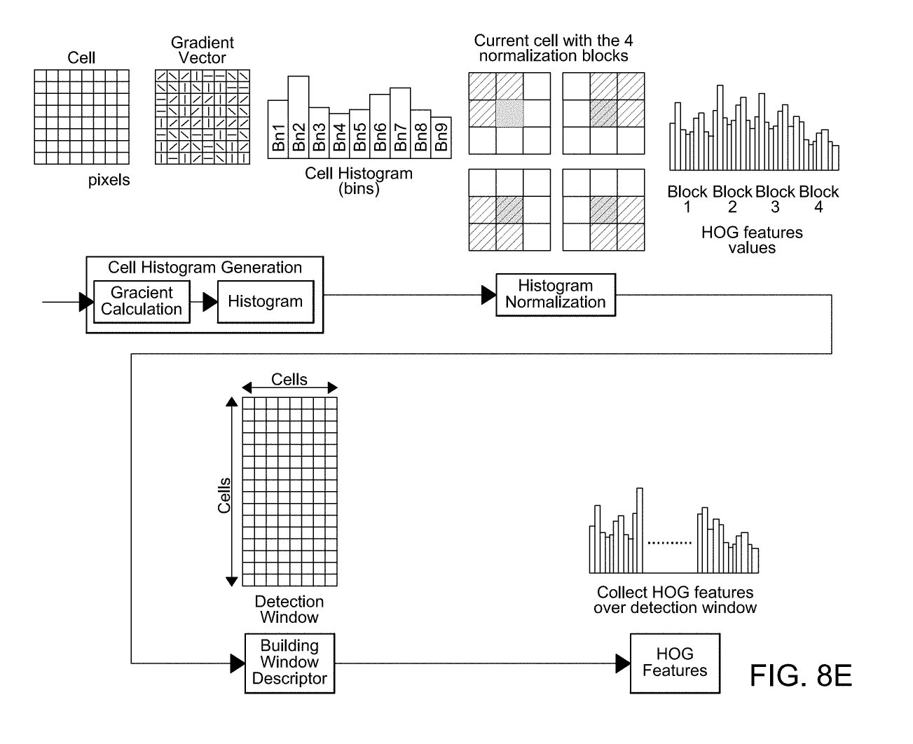

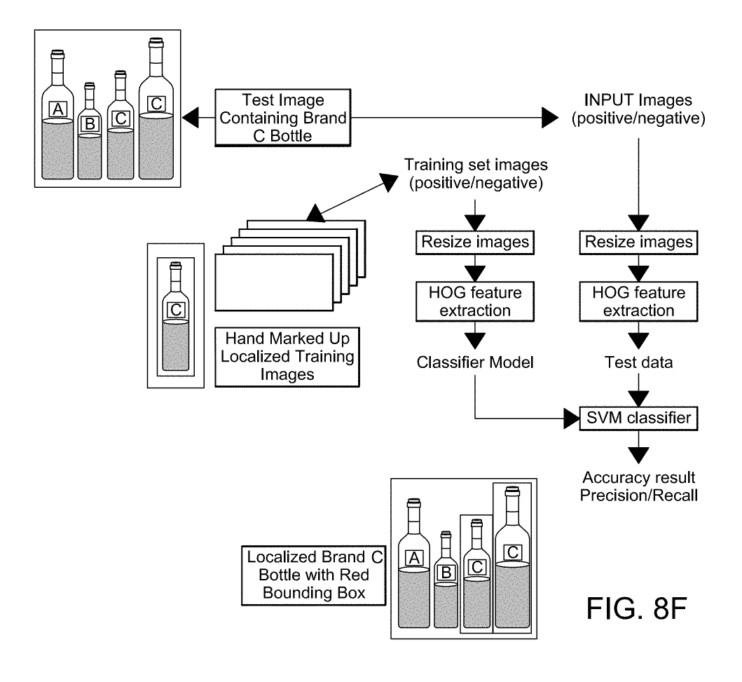

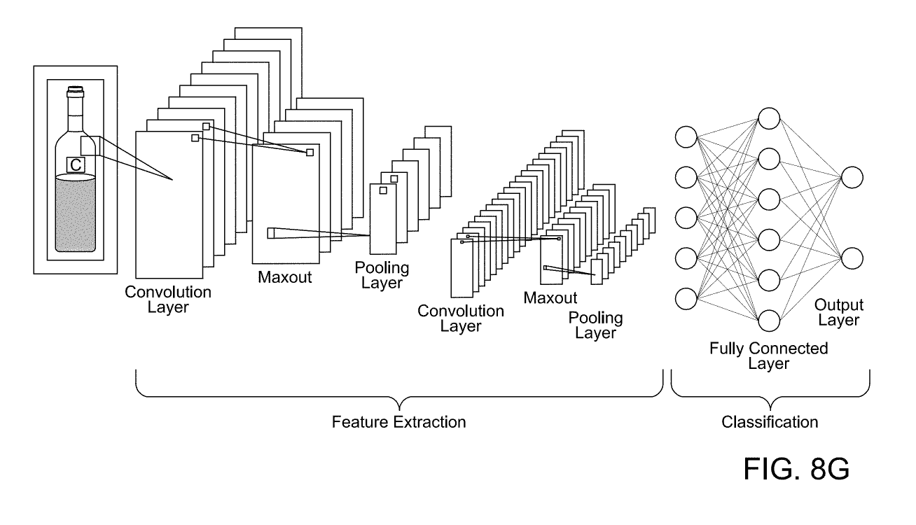

Graphical User Interface (GUI) functional module: The inventory technology can have a graphical user interface (GUI) module implemented on a smart device that can provide a selection menu to the user, as shown by the example in FIG. 4. The selection menu can provide a list of choices to select the type of the liquid container or bottle for which the inventory is to be done and the size of the liquid container, as shown by reference numerals 4A and 4B in FIG. 4. The user can select the specific model and the size of the liquid container for which he/she wants to do the inventory. After the selection of specific model and the size of the bottle, the inventory system can send the information of the selected model and size to the secondary device or cloud server inventory database using wireless communication or any other type of wired communication. The secondary device or cloud server database can send information required for the particular brand selected by the bartender back to the primary device which can be used by subsequent functional modules. This information can be specific landmark locations already defined on a database image of a particular brand of liquid container. The identified landmarks information can be used by the landmark detection functional module. Other information that can be sent back to the primary device includes a silhouette of the liquid container or boundary edges of the liquid in the container, as shown in FIG. 8. The silhouette or boundary edges of liquid container can be utilized for detection of the top, bottom, meniscus level location, etc. of the liquid container. This information can further be utilized in projective geometry correction and coordinate system conversion. The information regarding boundary edges of the liquid container can also be combined with the embedded sensor's information to provide visual guiding indicators for image orientation correction by the user or for automatic image orientation correction, as shown in FIG. 5A.

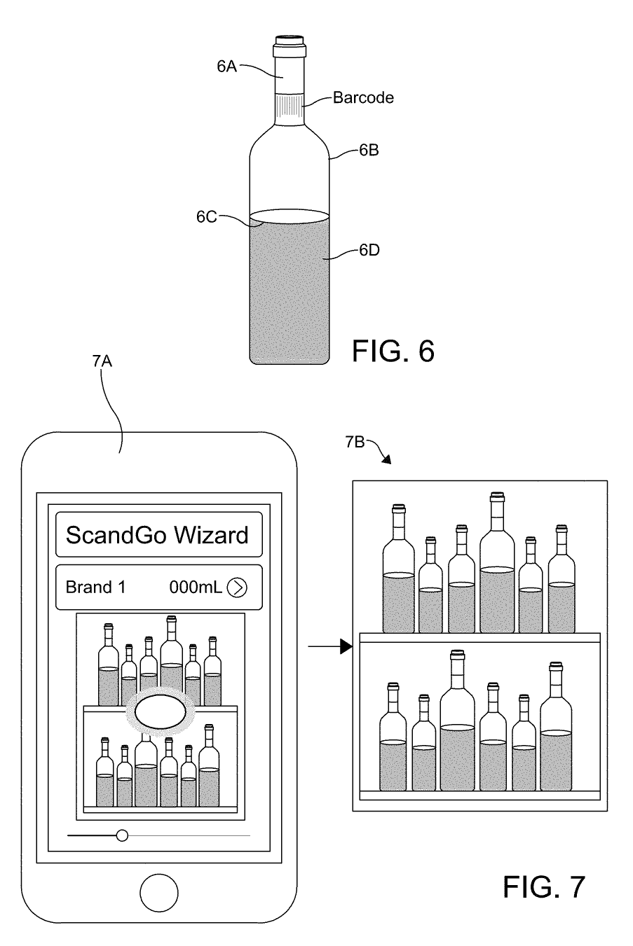

UPC barcode reading functional module: For some liquid containers, the labels may be damaged or torn off or landmark points may not be visible. Some of the liquid containers have a label an entire periphery thereof, effectively covering the surface of the container. Some of the liquid containers have opaque and dark surfaces, while some of the liquid containers have translucent liquid. In such situations, the liquid level may not be visible. In these scenarios, the image processing based technique for inventory system needs additional information for inventory determination. As such, the user can capture an image of the container such that the UPC or other identifying information is captured. The data associated with the UPC is retrieved from a remote source or can be stored on one or more servers. The user can then use the system to properly gauge the liquid level and/or can enter the measured liquid level manually by using the GUI provided by the inventory system. With reference to FIG. 6, reference numeral 6A represents a possible location of a UPC barcode. Reference numeral 6B shows the outline of the bottle, reference numeral 6C represents the meniscus level, and reference numeral 6D shows the remaining liquid.

Orientation and Centering Calculation functional module: The methods or systems of invention can use an embedded camera sensor, gyro, and/or accelerometer, to help calculate orientation of the smart device while the user is positioning the smart device for capturing the image of the liquid container. With reference to FIGS. 5A and 5B, the embedded gyro sensor provides a measurement of angular (rotational) velocity in 1, 2, or 3 directions. A 3-axis gyroscope with a 3-axis accelerometer can provide a full 6 degrees of freedom (DOF) motion tracking system. Other embedded sensors, for example a proximity sensor, an ambient light sensor, and a global position system (GPS) sensor, can provide additional information of the closeness or proximity of the smart device to an object (e.g., the liquid container), surrounding light information, as well as global position of the smart device. The methods or systems can check the availability of various embedded sensors on the smart device. Based on the availability of various embedded sensors, functionality of the overall system can be changed by activating different combinations of the various functionality modules, including those modules listed in FIG. 3. The ‘Orientation & Centering calculation functional module’ checks the availability of gyro and accelerometer and it also checks the availability of degree of freedom for the particular sensor. Based on this information, the module can decides which orientation calculation mechanism(s) can be utilized. If the smart device has full 6 degrees of freedom motion tracking system available, the ‘Orientation & Centering calculation functional module’ can calculate the tilting and centering information and provides such to the ‘Perspective Distortion Indication and/or correction functional module’ to correct the tilting and centering of the image being captured. If the smart device has lesser degrees of freedom available by virtue of non-availability of any sensor or non-availability of a degree of freedom, then the ‘Orientation calculation functional module’ provides the tilting and centering information to the ‘Perspective Distortion Indication and/or correction functional module’ to show the tilting and centering information of the image being captured on screen of GUI of the inventory system.

Perspective Distortion Indication and/or correction functional module: The methods and systems can use the orientation data and/or centering information of various embedded sensors to interactively indicate a level of perspective distortion to the user and allow the user to adjust the physical orientation of the image capture device to correct the distortion. If the “Orientation & Centering Calculation Module” provides the information to correct the perspective distortion, then the “Perspective Distortion Correction functional module” can correct the perspective distortion available in image being captured as shown in FIG. 5B. If the “Orientation & Centering Calculation Module” provides the information for of tilting and centering for visual indication to the user, then the “Perspective Distortion Indication functional module” can provide three visual indicators on the GUI, as shown in FIG. 5C. The visual indicators described in FIG. 5C are an example only. There can be multiple ways to show visual indicators on screen. Reference numeral 5C-A, shown as a bounding box on the GUI screen, provides a visual indication to the user to confine the entire liquid container's picture inside it. This allows the landmark detection functional module to capture the top, bottom, and other landmarks of the liquid container properly. The picture confining area indicator box is for example and not limited to the color and shape. Reference numeral 5C-B shows two circles trying to coincide. When the periphery of both of these circles do not perfectly coincide with each other, then the user will get an indication that the smart device is not vertically perpendicular to the liquid container. This can allow the user to try to tilt the smart device to achieve coincident peripheries of the circles. Reference numeral 5C-C shows a horizontal bar and a small circle on top of the line, indicating the horizontal orientation of the smart device, like a bubble in a level. When the smart device is not horizontally straight compared to the ground, the small circular ball will not come in the center of the horizontal line. This will provide a visual indication to the user about the horizontal tilt of the smart device which can result into a corrective action of tilting the smart device in the opposite direction by the user to keep the circular ball in the center of the horizontal line. The orientation and tilt visual indicators explained above are not limited to circular shapes and colors; they can take on any shape and color.

Image capture functional module: The image capture functional module automatically captures one or more images of a liquid container (e.g., bottle) when the desired orientation of image is achieved or allows the user to capture the image of the bottle for which the inventory is being done, along with surrounding bottles or other objects in the background. In an initial implementation, the user can capture the image of the liquid container using a background, having a known design for example, but not limited to, four dots printed on all four corners. With reference to FIG. 7, reference numeral 7A shows how the orientation and tilt alignment can be ensured by the image capture functional module on the GUI, where the captured image is taken from the inventory shown at reference numeral 7B. When the orientation and tilt alignment visual constraints described previously are satisfied, the functional module will capture the image automatically. As an example, but not limited to shapes and colors, when the two circles coincide perfectly, and when the rolling ball comes in the middle of the horizontal bar shown on the GUI screen, the functional module can capture the image automatically. The user can also press a capture button provided on the screen to capture the image of liquid container. The user can captures reliable and repeatable images of the bottle that are suitable for downstream processing. The user can therefore capture an image of the bottle for which the inventory is being done along with surrounding bottles or other objects in the same image frame. The localization functional module automatically finds the specific bottle for which the inventory is being done from the image having many objects available within the same image frame.

Primary or Secondary processing device selection functional module: The processing device selection functional module looks at the primary device's computational capabilities, and based on the available memory, processing power, and availability of sensors, the particular functional modules to be utilized on the primary computing device are selected. If the primary device has less computing power, less memory necessary to process computationally demanding functional modules, like liquid container localization and landmark detection modules, then the processing device selection functional module can select the secondary device to implement those computationally demanding functional modules. If the secondary device being utilized by the system is not capable enough to handle computationally demanding functional modules, then the processing device selection functional module can select additional secondary devices or one or more third party cloud-based processing devices to perform the computationally demanding functional modules.

Liquid Container or Bottle Localization functional module: The Liquid container or bottle localization functional module can automatically find the image of the liquid container or bottle for which the inventory is being done from the surrounding bottles or other objects in the image frame by using artificially trained neural network or by using various image processing techniques. Machine learning based techniques are implemented for localizing the bottle in the user captured image. This localization can be coarse (e.g., a bounding box) as shown in FIGS. 8B, 8C, and 8D, or can be fine (e.g., per pixel segmentation) as shown in FIG. 8A.

Fine Bottle Localization Using Pixel Imaging: Referring now to FIG. 8A, an illustrative bottle 10 is shown with UPC code 12 visible in the image. The contents 20 of the bottle (including meniscus 22 in the case of liquids) can also be seen. In FIG. 8A, the system creates a border 30 of the bottle which represents the bottle shape and total volume. In a preferred embodiment, the border is created using pixel imaging based fine localization. In FIG. 8B, the contents 20 and meniscus of the bottle are similarly pixelated. This can be achieved by the detection of constant/connected pixels (as discussed below). The volume of the contents 20 within bottle 10 are then calculated using pixel imaging algorithms.

The following methods for determining connected pixels are illustrative and are not presented in a limiting sense. Edge detection provides, inter alia, detection of changes in image brightness to capture important events and changes in properties of the captured image. Edges are areas where the goal is to identify points in an image which the image brightness changes sharply or edges characterize boundaries and are therefore a problem of fundamental importance in image processing. Edges in images are areas with strong intensity contrasts—a jump in intensity from one pixel to the next. Edge detecting an image significantly reduces the amount of data and filters out useless information, while preserving the important structural properties in an image. There are many ways to perform edge detection. However, the majority of different methods may be grouped into two categories, gradient and Laplacian. The gradient method detects the edges by looking for the maximum and minimum in the first derivative of the image. The Laplacian method searches for zero crossings in the second derivative of the image to find edges. An edge has the one-dimensional shape of a ramp and calculating the derivative of the image can highlight its location.

Blob analysis, for example, is aimed at detecting points and/or regions in the image that are either brighter or darker than the surrounding. There are two main classes of blob detectors (i) differential methods based on derivative expressions and (ii) methods based on local extrema in the intensity landscape. Image processing software comprises complex algorithms that have pixel values as inputs. For image processing, a blob is defined as a region of connected pixels. Blob analysis is the identification and study of these regions in an image. The algorithms discern pixels by their value and place them in one of two categories: the foreground (typically pixels with a non-zero value) or the background (pixels with a zero value). In typical applications that use blob analysis, the blob features usually calculated are area and perimeter, Feret diameter, blob shape, and location. Since a blob is a region of touching pixels, analysis tools typically consider touching foreground pixels to be part of the same blob. Consequently, what is easily identifiable by the human eye as several distinct but touching blobs may be interpreted by software as a single blob. Furthermore, any part of a blob that is in the background pixel state because of lighting or reflection is considered as background during analysis.

Blob analysis utilizes pixel neighborhoods and connectedness. The neighborhood of a pixel is the set of pixels that touch it. Thus, the neighborhood of a pixel can have a maximum of 8 pixels (images are always considered two dimensional). See FIG. 8C, where the shaded area forms the neighborhood of the pixel “p”. Referring to FIG. 8D, two pixels are said to be “connected” if they belong to the neighborhood of each other. All the shaded pixels are “connected” to ‘p’. One can connect pixel ‘p’ with other pixels by moving through 4 neighboring pixels available in adjacent top, adjacent bottom, adjacent left and adjacent right. Another method is to establish “8 pixels connectivity” by using all 8 neighboring pixels of pixel ‘p’ as shown in FIG. 8D. If one has several pixels, they are said to be connected if there is some “chain-of-connection” between any two pixels. The issue with the pixel imaging methods is that they provide lower performance with a difference in lighting conditions and are dependent on a different threshold to decide high or low intensity. For different images the threshold value varies, thus for automatic inventory system fine localization may not be useful.

Coarse Localization based on image features and image features classification: Out of many machine learning techniques, the inventory system can use histogram of oriented gradient (HOG) features and a Support Vector Machine (SVM) based classifier to find a region of interest to localize the bottle in the image for which inventory is being done. Though the combination of HOG and SVM are utilized to achieve localization of bottle, this section should not be considered to limit the method. Any feature vectors extracted from images and utilization of such features for training and testing an image classifier or any neural network classifier can provide similar functionality required for this functional module.

The histogram of oriented gradients (HOG) is a feature descriptor computed by counting occurrences of gradient orientation in localized portions of an image. This method is similar to that of edge orientation histograms, scale-invariant feature transform (SIFT) descriptors, and shape contexts, but differs in that it is computed on a dense grid of uniformly spaced cells and uses overlapping local contrast normalization for improved accuracy.

Referring to FIG. 8E, HOG is implemented using the following steps:
(1) Cells: divide the image into small connected regions called cells;
(2) Gradient computation: for each cell, compute a histogram of gradient directions or edge orientations for the pixels within the cell;
(3) Orientation binning: discretize each cell into angular bins according to the gradient orientation, each cell's pixel contributes weighted gradient to its corresponding angular bin;
(4) Groups of adjacent cells are considered as spatial regions called blocks, the grouping of cells into a block is the basis for grouping and normalization of histograms;
(5) Block normalization: normalized group of histograms represents the block histogram; and
(6) HOG descriptor and feature vector: the set of these block histograms are grouped as the HOG descriptors or feature vectors.

Support Vector Machine Classifier: Another step in coarse bottle localization is to feed histogram of oriented gradient descriptors computed in the previous step of the functional module into some recognition system based on supervised learning. The support vector machine (SVM) classifier is a binary classifier which looks for an optimal hyperplane as a decision function. Reference is made to FIGS. 8E and 8F, which outline how the HOG feature vectors are used for training and later on to localize the test image. Once trained on images containing some particular brand and size of the bottle or liquid container, the SVM classifier can make decisions regarding the presence of an object, such as a specific brand and size of bottle or liquid container, in additional test images. For example in FIG. 8F the SVM classifier can decide which size bottle of Brand C is being localized.

Coarse Localization based on machine learning technique: Coarse Localization can be also performed without extracting features from images; however, a machine learning technique can be used that can be trained by using an ample amount of example images. Machine learning techniques are referred to herein in a general sense, which can include any supervised learning—e.g., regression, decision tree, random forest, neural network, logistic regression; unsupervised learning—e.g., K-means; reinforcement learning technique—e.g., Markov decision process; deep learning technique—e.g., Deep Convolutional Neural Network (DCNN), deep recurrent neural network, etc.

With reference to FIG. 8G, a coarse localization of a liquid container is implemented using a deep convolutional neural network (CNN). A CNN includes an input and an output layer, as well as multiple hidden layers. The hidden layers are either convolutional, pooling, or fully connected, where each are further described below.

Convolutional layers apply a convolution operation to the input, passing the result to the next layer. The convolution emulates the response of an individual neuron to visual stimuli. Each convolutional neuron processes data only for its receptive field. Tiling allows CNNs to tolerate translation of the input image (e.g., translation, rotation, perspective distortion). Although fully connected feed-forward neural networks can be used to learn features as well as classify data, it is not practical to apply this architecture to images. A very high number of neurons would be necessary even in a shallow architecture (opposite of deep). The convolution operation brings a solution to this problem as it reduces the number of free parameters, allowing the network to be deeper with much less parameters. In other words, it resolves the vanishing or exploding problems in training traditional multi-layer neural networks with many layers by using back-propagation.

Convolutional networks may include local or global pooling layers, which combine the outputs of neuron clusters at one layer into a single neuron in the next layer. For example, maximum pooling uses the maximum value from each of a cluster of neurons at the prior layer. Another example is average pooling, which uses the average value from each of a cluster of neurons at the prior layer.

Fully connected layers connect every neuron in one layer to every neuron in another layer. It is in principle the same as the traditional multi-layer perceptron neural network (MLP).

CNNs can share weights in convolutional layers, which means that the same filter (weights bank) can be used for each receptive field in the layer; this reduces memory footprint and improves performance. A fully trained localization functional module will provide a region of interest boundary automatically when the image of the liquid container is sent to it as an input.

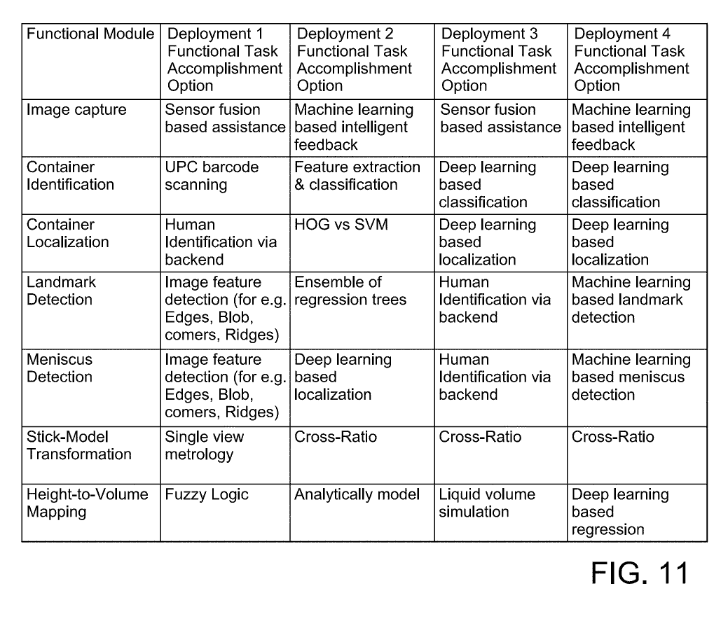

Liquid Container or Bottle Landmark detection functional module: Liquid container or bottle landmarks can be identified by using multiple options, including the examples provided in FIG. 1A-C, FIG. 3, and FIG. 11. The functional task is to identify various positions (e.g., 4 or more known fixed positions) on the bottle in the localized ROI by human markers or by image processing techniques; e.g., Ensemble of regression trees, or by machine learning techniques, for a specific brand and size of the liquid container and send it back to a cloud server.

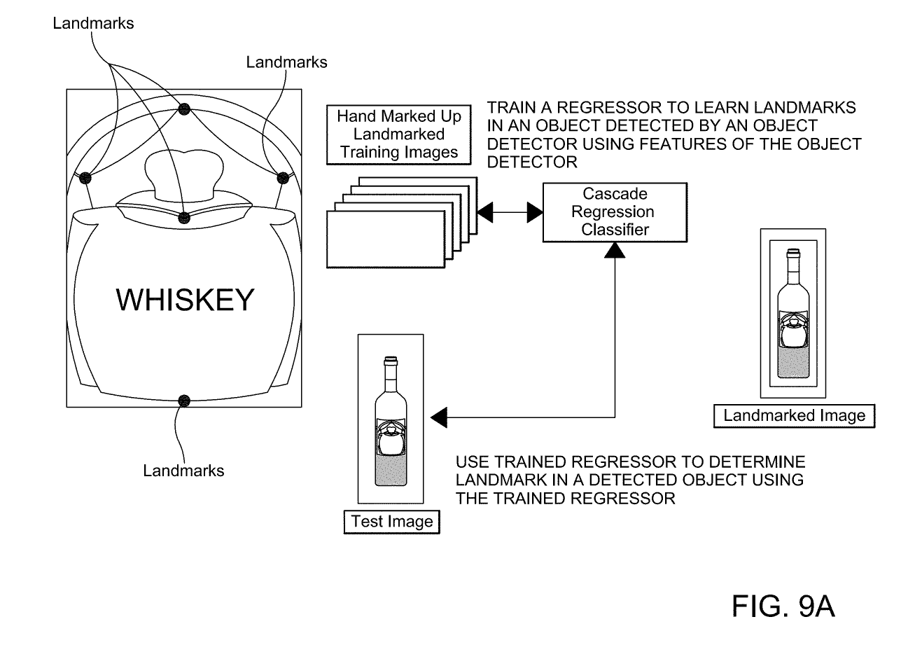

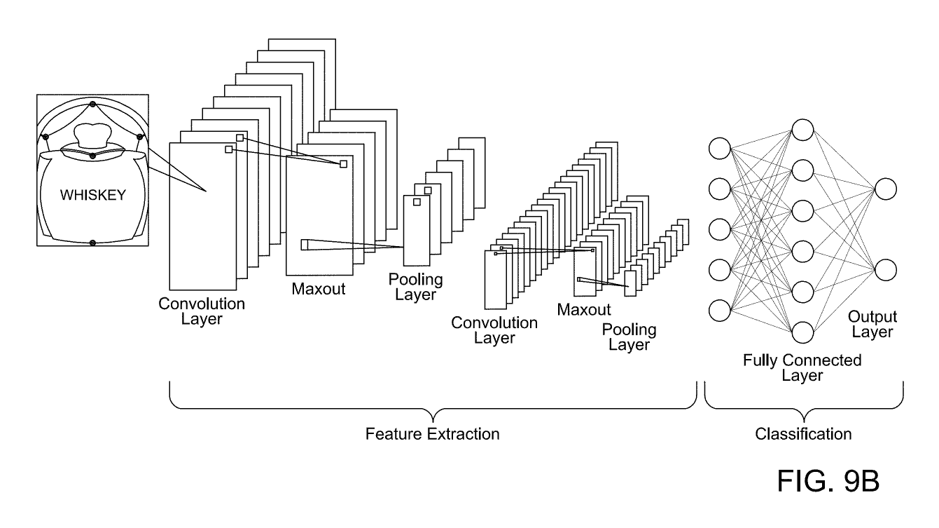

Landmark points: For each and every type of the brand and size of the liquid container or bottle, one or more landmark points can be identified. The reference to ‘points’ is for example only, there can be landmark designs or any other such mechanism which can represent a landmark on a liquid container, its surrounding, color, shape, silhouette, lid or cap shape, lid or cap color, liquid container or bottle's label, etc. With reference to FIG. 9A, one of the many examples of landmark points (e.g., five black dots on the “whiskey” label) and use thereof is shown.

Liquid container or bottle landmark detection using Ensemble of regression trees: With reference to FIG. 9B, a cascade or ensemble regression tree classifier can be used to classify landmarks provided the classifier is trained a priori using the hand marked landmark images. A regression tree ensemble is a predictive model composed of a weighted combination of multiple regression trees. In general, combining multiple regression trees increases predictive performance. This image processing technique can work with facial landmark point detection, for example. Other examples include work by Vahid Kazemi and Josephine Sullivan, titled-“One Millisecond Face Alignment with an Ensemble of Regression Trees.” The functional module utilizes the ensemble of regression trees for liquid containers or bottles in the inventory system.

Liquid container or bottle landmark detection using machine learning techniques: Liquid container or bottle landmark detection can also be performed using a machine learning technique which needs to be trained by using ample amount of example images. Landmark detection of a liquid container is implemented using a deep convolutional neural network, as described herein. The terminology of machine learning, however, is not limited to a deep convolutional neural network Landmark detection using machine learning techniques can employ the aspects of a convolutional neural network (CNN), as described herein. A fully trained landmark detection functional module can provide landmark points automatically on an image patch constructed after localized region of interest boundary is detected.

Liquid Container or Bottle Liquid or Meniscus detection functional module: Liquid container or bottle meniscus can be identified by using multiple options as listed, but not limited to, in FIGS. 1A-C, 3, and 11. The functional task is to identify a meniscus level in a localized region of interest (ROI) in the pixels domain by using pixelization techniques (e.g., Edges, Blob, Corners, Ridges) or by using machine learning techniques by using human marked images for training the machine learning technique for a specific brand and size of the liquid container and send it back to cloud server, where these techniques can include the aspects already described herein.

Projective Geometry Correction and Coordinate system conversion “Stick Model transformation” functional module: Once the meniscus level is identified in pixel domains, the stick model functional module can use projective geometry to transform pixel position of the landmark and meniscus in to real world coordinates to calculate a representative height or level of liquid in the container. This functional task can be accomplished by using multiple options as listed, including those provided in FIGS. 1A-C, 3, and 11.

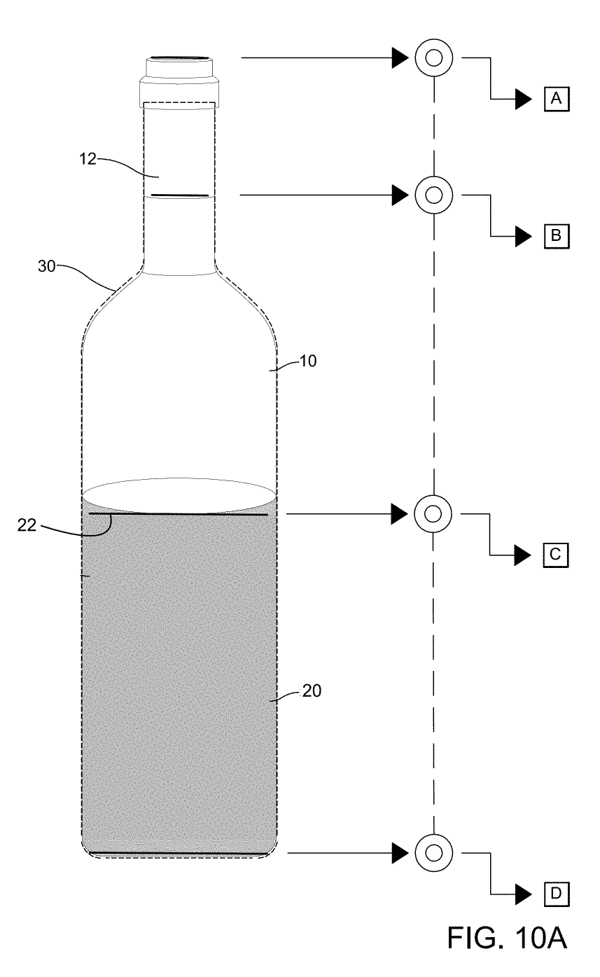

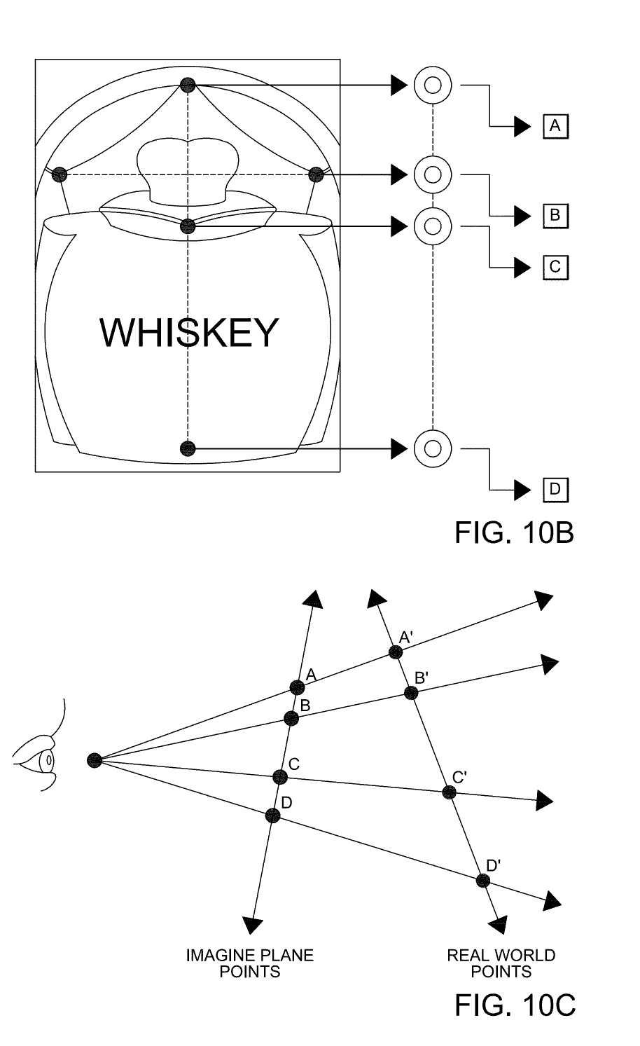

Stick Model: As shown in FIG. 10A and FIG. 10B, the inventory system can define a stick model as a representative feature showing a projection of landmarks on to a single one-dimensional line. The bottle 10 can be similar to FIG. 8A and FIG. 8B, where an illustrative bottle 10 is shown with a label 12 that can include a barcode or UPC code, liquid contents 20 including a meniscus 22 thereof, and a border 30 representing the bottle shape and total volume. With reference to FIG. 10A, the stick model for an example bottle is shown in which the landmark points are identified as collinear points hand marked or identified on top of bottle A, cap bottom B, meniscus level C, and bottom of bottle D, and or any other similar point on the same line. With reference to FIG. 10B, the stick model for another type of landmark is shown in which the landmark points are identified on the image plane and then projected back on to a line to construct a stick model. Similarly for each and every brand and size of liquid container or bottle, a stick model can be computed and can be stored in a database.

Stick Model transformation using cross ratio: It is known that projective geometry preserves neither distances nor ratios of distances. However, the cross ratio, which is a ratio of ratios of distances, is preserved in a projective transformation. The cross-ratio (ABCD) of four collinear points A, B, C, D is defined as the “double ratio” (also known as anharmonic ratio: (A,B; C,D)=CA/CB:DA/DB, which is preserved in real world co-ordinates to image plane co-ordinate. Once the meniscus level position is known in image plane, the height or level of the meniscus in the real-world coordinate or real world measurement unit can be found out using cross-ratio transformation. A similar technique to perform geometrical corrections is single view metrology proposed by A. Criminisi et al.

Liquid Container remaining liquid volume calculation functional module: This functional module converts representative height or level of meniscus level computed in previous functional module to remaining liquid volume using a predetermined calibration dataset based on experimental or other measures. The functional module can accomplish the functional task by using many different options as listed in FIGS. 1A-C, 3, and 11. These can use, for example, fuzzy logic techniques, deep learning based regression, analytical model, and liquid volume simulation.

Mapping based inference utilizing the above height or level information, the server functional module can calculate the interior volume of the bottle and the volume of liquid contained within the bottle, including the known volume of liquid contained within the bottle at time of shipment. By determining the relative height or level of the contents relative to the height of the bottle, the functional module calculates the ratio of the contents (liquid) height/contents container height which equals the actual filled ratio, i.e., the contents height as a percentage of the contents container height. Utilizing this information, knowing the volume of the container along the height of the container, as can be calculated utilizing complex geometric shapes to account for curvature and the like, as well as the neck, the functional module converts the actual filled ratio to the volume of liquid remaining in the bottle. The functional module may calculate the contents volume as a function of the height or level of the liquid as indicated by the digital image and the known diameter of the bottle, the container height, and the actual filled ratio. In some embodiments, the equation can be derived by using the method of least squares or any other suitable mathematical method for fitting a curve or line of best fit to a set of data. The methodology may use any type of regression analysis or other statistical methods to make this equation as accurate as possible. This equation may be any real value continuous function and may be to the desired degree of accuracy.

In order to provide the most accurate measurement of contents volume, the image filled ratio, i.e., the percentage represented by the content height divided by the total image height, must be matched to the actual filled ratio, which as described above, is the contents height divided by the contents container height. By way of example, if a one liter is the bottle in question as captured and discussed above, and the border height corresponds to a contents height of 53.44234 percent of the overall image height, the actual filled ratio of that position along the actual bottles is 0.5344234. However, when accounting for the curves or neck of the bottle, this relationship can change.

Model refinement functional module: The methods and systems can use the current results in aggregation with prior results and/or human feedback to update models in all or any of the steps described herein. See FIG. 11. As explained herein, there can be multiple combinations of functional modules actively deployed in any mobile computing device depending on the need and the availability of the computing processing power of the computing device. FIG. 11 outlines that anywhere from one to four deployments can be simultaneously working while having different functional modules activated. The model refinement functional module continuously aggregates the learning captured from all the functional modules and continues improving and updating the models in all or any of the steps.

Inventory database information linking functional module: The methods and systems can send the computed volume information to an inventory database of the liquid containers, where the inventory database can be stored on one or more devices or servers.

Inventory analysis and GUI functional module: The methods and systems can implement an analytic GUI and database system on one or more secondary processing systems to provide analytic insights required for inventory management. The functional module aggregates the total volume of liquid at each section by combining a determined volume for open bottles and determine volume for full bottles at each location. The functional module can then time and date stamp the just input inventory and store that inventory as the inventory at that time and date. By comparing to the previous inventory, and determining a difference in liquid volumes for each type of drink at each location within the establishment, an amount consumed can be determined as a function of contents, location within a particular bar, and even a bar within a particular establishment. Furthermore, where a single owner has more than one establishment, inventories may be aggregated to determine contents consumption by contents type, bar location, and establishment location across all of the establishments. It should be noted that the functional module may be synchronized each time a digital image including the content height is input or each time the user changes the contents type so that after taking inventory of each section of a bar, the data is sent to the functional module rather than waiting to sync at the very end and risking loss of any data during the intervening activities.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for providing an inventory of a liquid in a container comprising:
a mobile device including a sensor, the sensor configured to capture an image of the container;
a database configured to store an attribute of the container;
a computational device in communication with the mobile device and the database, the computational device configured with an image processing means, the image processing means configured to process the image of the container to identify a type of the container by using the attribute of the container and to identify the liquid in the container, the computational device configured to determine an amount of the liquid in the container using the type of the container identified by the image processing means and using the liquid in the container identified by the image processing means; and
a reporting means configured to report the amount of the liquid in the container.

2. The system of claim 1, wherein:
the sensor is configured to capture a plurality of time stamped images of a plurality of containers from a plurality of recorded relative spatial orientations;
the computational device is configured with an image processing means to identify a plurality of individual containers that have moved with respect to each other from one time stamped image to another; and
the reporting means is configured to report the containers which have moved from one time stamped image to another.

3. The system of claim 1, wherein the sensor configured to capture an image of the container includes a digital camera.

4. The system of claim 1, wherein the mobile device further comprises another sensor selected from the group consisting of: a gyroscope, an accelerometer, a global positioning system receiver, a barcode scanner, a barometer, a magnetometer, a proximity sensor, and combinations thereof.

5. The system of claim 1, wherein one of the database, the computational device, and the database and the computational device is integrated into the mobile device.

6. The system of claim 1, wherein one of the database, the computational device, and the database and the computational device is remote from the mobile device.

7. The system of claim 6, wherein the one of the database, the computational device, and the database and the computational device is in wireless communication with the mobile device.

8. The system of claim 1, wherein the mobile device includes a graphical user interface functional module including a selection menu for selecting the attribute from the database, the attribute including a member selected from the group consisting of a brand, a container size, and combinations thereof.

9. The system of claim 8, wherein the mobile device includes a touchscreen configured to operate the graphical user interface functional module.

10. The system of claim 9, wherein the reporting means is integrated into the mobile device and the reporting means includes the touchscreen configured to operate the graphical user interface functional module.

11. The system of claim 1, further comprising a classification functional module configured to autonomously identify the container and the attribute of the container based on a sensor input from the mobile device.

12. The system of claim 1, further comprising a universal purchasing code barcode reading functional module configured to identify a universal purchasing code barcode in the image of the container, the attribute of the container including information identifying the universal purchasing code barcode on the container.

13. The system of claim 1, wherein the mobile device includes an orientation and centering calculation functional module configured to determine an orientation of the mobile device relative to the container.

14. The system of claim 13, wherein the orientation of the mobile device includes a tilt parameter and a centering parameter.

15. The system of claim 13, further comprising a perspective distortion indication and correction functional module configured to provide an operation selected from the group consisting of: correct the image of the container using the orientation of the mobile device relative to the container to minimize perspective distortion; provide an indicator responsive to the orientation of the mobile device relative to the container, the indicator indicating when the orientation of the mobile device relative to the container minimizes perspective distortion; and combinations thereof.

16. The system of claim 15, wherein the indicator is selected from the group consisting of: a boundary of the container in the image of the container; a vertical indicator identifying a vertical alignment of the mobile device relative to the container; a horizontal indicator identifying a horizontal alignment of the mobile device relative to the container; and combinations thereof.

17. The system of claim 15, further comprising an image capture functional module configured to automatically use the sensor to capture the image of the container when the indicator indicates the orientation of the mobile device relative to the container has minimized perspective distortion.

18. The system of claim 1, further comprising a processing device selection functional module configured to ascertain performance of the image processing means of the computational device and to include communication with another computational device when performance of the image processing is substantially at a maximum capacity, wherein the another computational device is remote from the computational device.

19. The system of claim 1, further comprising a liquid container localization functional module configured to identify the container relative to at least one other container within the image of the container.

20. The system of claim 19, wherein the liquid container localization functional module uses fine localization based on pixel imaging of the image of the container.

21. The system of claim 19, wherein the liquid container localization functional module uses coarse localization based on a histogram of oriented gradient features and a support vector machine based classifier to find a region of interest to localize the container in the image of the container.

22. The system of claim 19, wherein the liquid container localization functional module uses coarse localization based on a machine learning means configured to identify the container in the image of the container from analysis of a plurality of example images of the container.

23. The system of claim 1, further comprising a liquid container landmark detection functional module configured to identify a plurality of container landmarks in the image of the container indicative of the attribute of the container.

24. The system of claim 23, wherein the plurality of container landmarks includes a member selected from the group consisting of: a color, a shape, a silhouette, a lid or cap shape, a lid or cap color, a label shape, a label color, a label indicia, a label graphic, and combinations thereof.

25. The system of claim 23, wherein the liquid container landmark detection functional module uses a regression tree ensemble.

26. The system of claim 23, wherein the liquid container landmark detection functional module uses a machine learning means configured to identify the container landmarks in the image of the container from analysis of a plurality of example images of the container.

27. The system of claim 23, further comprising a liquid container meniscus detection functional module configured to identify a meniscus level of the liquid in the image of the container using a pixelization technique, a machine learning means, or human input.

28. The system of claim 27, further comprising a projective geometry correction and coordinate system conversion functional module configured to transform the meniscus level and the plurality of landmarks into real-world coordinates to determine a representative level of the liquid in the container.

29. The system of claim 28, further comprising a liquid container remaining liquid volume calculation functional module configured to convert the representative level of the liquid in the container to the amount of liquid in the container using a predetermined calibration dataset.

30. The system of claim 1, further comprising an inventory database information linking functional module configured to communicate the amount of the liquid in the container to an inventory database.

31. The system of claim 30, wherein the inventory database is configured to relate the amount of the liquid in the container to a member selected from the group consisting of: a prior value for the amount of the liquid in the container; a particular establishment; a location within a particular establishment; a date; a time; and combinations thereof.

32. The system of claim 1, wherein the reporting means includes a member selected from the group consisting of: a display; a touchscreen; a graphical user interface; and combinations thereof.
